(19) United States
(12) Patent Application Publication
(10) Pub. No.: US 2025/0316727 A1
(43) Pub. Date: Oct. 9, 2025

(54) FUEL CELL SYSTEM AND METHOD FOR OPERATING A FUEL CELL SYSTEM

(71) Applicant: Purem GmbH, Neunkirchen (DE)

(72) Inventors: Gerd Gaiser, Reutlingen (DE); Tobias Lehr, Esslingen (DE); Bernd Weller, Durlangen (DE); Markus Birgler, Wernau (DE)

(21) Appl. No.: 19/169,869

(22) Filed: Apr. 3, 2025

(30) Foreign Application Priority Data
Apr. 4, 2024 (DE) 10 2024 109 374.9

(51) Int. Cl. H01M 8/04082; H01M 8/04089

(52) U.S. Cl. CPC H01M 8/04201; H01M 8/04089; H01M 2250/20

(57) ABSTRACT

A fuel cell system, in particular for a vehicle, includes at least one fuel cell having an anode region to be fed with hydrogen-containing anode gas at an anode inlet region, a cathode region to be fed with oxygen-containing cathode gas at a cathode inlet region, an anode outlet region for releasing anode offgas, and a cathode outlet region for releasing cathode offgas, and also a buffer store for receiving anode offgas from the anode outlet region.

### CROSS-REFERENCE TO RELATED APPLICATIONS

This application claims priority of German patent application no. 10 2024 109 374.9, filed Apr. 4, 2024, the entire content of which is incorporated herein by reference.

### TECHNICAL FIELD

The present disclosure relates to a fuel cell system which can be used, for example, for generating electrical energy in an electrically powered vehicle. Such a fuel cell system includes at least one fuel cell, for example in the form of a fuel cell stack, having an anode region to be fed with hydrogen-containing anode gas at an anode inlet region, a cathode region to be fed with oxygen-containing cathode gas at a cathode inlet region, an anode outlet region for releasing anode offgas, and a cathode outlet region for releasing cathode offgas.

### BACKGROUND

The membrane separating the anode region from the cathode region in such fuel cells generally has a residual permeability for nitrogen and water, which means that, during fuel cell operation, nitrogen present in the cathode gas provided via air, for example, and water produced in or introduced into the cathode region can diffuse through the membrane into the anode region. The accumulation of nitrogen and water in the anode region leads to a dilution of the anode gas introduced into the anode region and therefore adversely affects the efficiency of the fuel cell.

In order to counter this problem, anode region flushes, which are referred to as purges, are carried out repeatedly in the fuel cells, for example at intervals of 20 seconds to 2 minutes, the flushes involving opening the anode region briefly, for example for a period of 0.1 to 1 second. The positive pressure generally present in the anode region, for example in the range from 2 to 3.5 bar, results in a rapid outflow of the gas mixture which is present in the anode region and which, in addition to the contaminants that have reached the anode region by diffusion, also contains a high proportion of molecular hydrogen. If such a gas mixture is emitted to the environment as anode offgas during a flush and mixed with oxygen present in the ambient air, there is the risk that the ignition limit will be exceeded and that the mixture of hydrogen and oxygen will start to burn or will explode.

In order to prevent this, the fuel cell offgas released from the fuel cell during a flush can also be conducted through a catalyst unit in which a mixture of hydrogen and oxygen is reacted in a controlled manner. In time intervals between two flushes, the hydrogen concentration in the fuel cell offgas is comparatively low, which means that it would be possible in principle to use a small-sized catalyst unit to provide sufficient reaction capacity. While carrying out flushes, there is sharp rise in the hydrogen concentration and thus the amount of hydrogen to be reacted, which, for sufficient catalytic conversion of the hydrogen flushed out, requires a catalyst unit that is oversized for normal operation of a fuel cell system.

### SUMMARY

It is an object of the present disclosure to provide a fuel cell system and a method for operating such a fuel cell system, both of which can reliably avoid releasing fuel cell offgas having an excessively high hydrogen concentration to the environment.

According to the present disclosure, this object is achieved by a fuel cell system, in particular for a vehicle, including:
at least one fuel cell having an anode region to be fed with hydrogen-containing anode gas at an anode inlet region, a cathode region to be fed with oxygen-containing cathode gas at a cathode inlet region, an anode outlet region for releasing anode offgas, and a cathode outlet region for releasing cathode offgas,
an anode offgas buffer store for receiving anode offgas from the anode outlet region.

In a fuel cell system constructed according to the disclosure, the anode offgas released during an anode region flush is not conducted directly into an offgas system, for example one containing a catalyst unit, or released to the environment, but is instead stored temporarily in the buffer store. The anode offgas conducted into the buffer store during an anode region flush is released with a time delay or over the period of time between two anode region flushes. As a result, downstream of the buffer store is a distinct reduction in the amount of hydrogen transferred per unit of time, which means, firstly, that exceeding of the ignition limit can be avoided and that substantially complete catalytic conversion of the hydrogen flushed out during such anode region flushes can be ensured with use of a catalyst unit of a comparatively small size. Since such a catalytic reaction can then proceed virtually continuously over a relatively long period of time, there is no risk that the catalyst unit will cool down between two anode region flushes and be excessively exposed to the water present in the cathode offgas.

In order to be able to supply the buffer store with anode offgas in a defined and controlled manner when carrying out anode region flushes, the buffer store may be connected to the anode outlet region via a buffer store inlet line and the buffer store inlet line may be associated with a buffer store valve unit for either unblocking the buffer store inlet line to allow supply of anode offgas to the buffer store or blocking the buffer store inlet line to prevent supply of anode offgas to the buffer store.

In order to also avoid the emission of incompletely converted hydrogen in the anode region during normal fuel cell operation, the anode outlet region may be associated with an anode return line for returning anode offgas from the anode outlet region to the anode inlet region.

For a structurally simple configuration, the buffer store inlet line may be connected to the anode return line. For example, the buffer store inlet line may branch off from the anode return line.

To obtain a defined flow of cathode gas through the cathode region and to also set defined pressure conditions in the cathode region, the cathode outlet region may be associated with a cathode outlet line for releasing cathode offgas and the cathode outlet line may be associated with a cathode valve unit for either unblocking the cathode outlet line to allow release of cathode offgas from the cathode outlet region or blocking the cathode outlet line to prevent release of cathode offgas from the cathode outlet region. Not only can the cathode outlet region preferably be completely blocked to prevent the release of cathode offgas or maximally unblocked to allow the release of cathode offgas via the cathode valve unit, but it is also possible to use the cathode valve unit as a pressure control valve, via which the pressure in the cathode region can also be adjusted to a required or optimal pressure in line with the load state of the fuel cell through defined setting of the restricting action produced by the cathode valve unit.

To release the anode offgas introduced into the buffer store, the buffer store may be associated with a buffer store outlet line for releasing anode offgas from the buffer store and the buffer store outlet line may be associated with a buffer store restrictor unit for restricting the flow of anode offgas through the buffer store outlet line.

In order to be able to adapt the release of anode offgas from the buffer store, for example, to the load state of the fuel cell, it is proposed that the buffer store restrictor unit have alterable restricting behavior.

The buffer store outlet line may, for example, open into the cathode outlet line downstream of the cathode valve unit.

In order to be able to reactively convert in a controlled manner the hydrogen released during fuel cell operation, in particular when carrying out anode region flushes, and in order to be able to use the heat released in this process, for example in a vehicle, a catalyst unit may be provided for receiving cathode offgas from the cathode outlet region or/and anode offgas from the anode outlet region.

The cathode outlet line may open into the catalyst unit downstream of the cathode valve unit and the buffer store outlet line may open into the cathode outlet line upstream of the catalyst unit.

To influence the pressure conditions in the cathode region, the cathode region may be associated with a cathode bypass line and the cathode bypass line may be associated with a bypass valve unit for either unblocking the cathode bypass line to allow conduction of cathode gas parallel to the cathode region or blocking the cathode bypass line to prevent conduction of cathode gas parallel to the cathode region.

If the cathode bypass line opens into the cathode outlet line downstream of the cathode valve unit, both the bypass valve unit and the cathode valve unit can be used to set defined pressure conditions in the cathode region.

The cathode inlet region may be associated with a cathode inlet line for conducting cathode gas to the cathode region, and the anode region may be associated with an anode inlet line for conducting anode gas to the anode region.

A defined supply of cathode gas to the cathode region in terms of amount and temperature may be ensured, for example, by associating the cathode inlet line with a cathode gas conveyance unit for conveying cathode gas to the cathode region and with a cathode gas heating unit for heating cathode gas conveyed to the cathode region.

It is particularly advantageous if the cathode bypass line branches off from the cathode inlet line downstream of the cathode gas heating unit. Therefore, it is possible for cathode gas heated at the cathode gas heating unit to be conducted through the cathode bypass line into a downstream catalyst unit and to be conditioned thereby, both thermally and with respect to water accumulation.

In order for water flushed into the buffer store with the anode offgas from the anode region not to excessively accumulate in the buffer store, the buffer store may be associated with a fluid outlet line and the fluid outlet line may be associated with a fluid valve unit for either unblocking the fluid outlet line to allow release of fluid from the buffer store or blocking the fluid outlet line to prevent release of fluid from the buffer store.

The object stated at the start is further achieved by a method for operating a fuel cell system constructed according to the disclosure, which method includes conducting anode offgas released from the anode outlet region into the buffer store when carrying out an anode region flush.

For an even release of the hydrogen flushed out of the anode region, it is proposed that the restricting behavior of the buffer store restrictor unit be adjusted depending on a load state of the fuel cell when carrying out an anode region flush.

For example, for this purpose, the restricting behavior of the buffer store restrictor unit may be adjusted such that the restricting action of the buffer store restrictor unit decreases as the fuel cell load increases.

As a result of anode offgas being conducted away from the anode region during an anode region flush, there is a distinct drop in the gas pressure in the anode region compared to the gas pressure during normal fuel cell operation. In order to avoid an overload of the membrane separating the anode region from the cathode region due to an excessively large pressure difference between the anode region and the cathode region, a gas pressure in the cathode region may be lowered when carrying out an anode region flush.

The gas pressure in the cathode region may be lowered by adjusting the cathode valve unit in the direction of lower restricting action, such that the counter-pressure at the cathode outlet region decreases and the release of a relatively large amount of cathode offgas can lower the pressure in the cathode region.

Alternatively or additionally, the gas pressure in the cathode region may be lowered by operating the bypass valve unit to unblock the cathode bypass line.

### BRIEF DESCRIPTION OF DRAWINGS

The invention will now be described with reference to the drawing wherein:

FIG. 1 shows a schematic illustration of a fuel cell system usable for generating electrical energy in a vehicle, for example.

### DETAILED DESCRIPTION

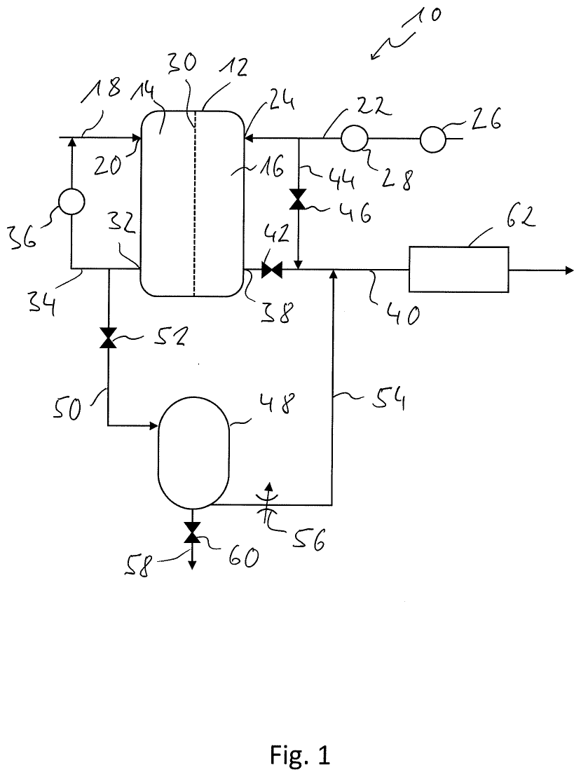

In FIG. 1, a fuel cell system usable for generating electrical energy in a vehicle, for example, is denoted as a whole by 10. The fuel cell system 10 includes a fuel cell 12, for example in the form of a fuel cell stack, having an anode region 14 and a cathode region 16. The anode region 14 is supplied with molecular hydrogen or a molecular hydrogen-containing gas as anode gas via an anode inlet line 18, the anode gas being introduced into the anode region in an anode inlet region 20. For example, the hydrogen, or the anode gas, may be taken from a cryotank. The cathode region 16 is supplied with a cathode gas containing oxygen as oxidizing agent via a cathode inlet line 22, the cathode gas being introduced into the cathode region at a cathode inlet region 24. For example, the cathode gas used may be air, which means that the atmospheric oxygen present in the air may be used as oxidizing agent in the fuel cell 12. It should be noted that the use of oxygen is just one example of a multitude of other further oxidizing agents which can be used in a fuel cell to generate electrical energy by reacting with hydrogen.

The cathode inlet line 22 is associated with a cathode gas conveyance unit 26, for example in the form of a blower or compressor. Downstream of the cathode gas conveyance unit 26, the cathode inlet line 22 is associated with a cathode gas heating unit 28, in which the cathode gas conveyed toward the cathode inlet region 24 can be heated, for example by energizing an electrically energizable heating module.

The cathode region 14 and the anode region 16 are separated from one another by a membrane 30 which is fundamentally proton-permeable.

The anode region 14 has an anode outlet region 32 at which anode offgas is released into an anode return line 34. The anode offgas received in the anode return line 34 can be returned to the anode inlet line 18 and the anode inlet region 20 under the conveying effect of an anode offgas conveyance unit 36, for example in the form of a compressor or the like, such that hydrogen present in the anode offgas can be returned to fuel cell operation.

The cathode region 16 has a cathode outlet region 38 at which cathode offgas is released into a cathode outlet line 40. The cathode outlet line 40 is associated with a cathode valve unit 42 via which the cathode outlet region 38 and the cathode outlet line 40 can be blocked to prevent cathode offgas from flowing through or unblocked to allow the cathode offgas to flow through. The cathode valve unit 42 may also be used as a pressure control valve, such that optimal pressure conditions in the cathode region 16 for fuel cell operation 12 can be set by adjusting the restricting action of the cathode valve unit 42. The cathode valve unit 42 may be, for example, under the control of a control unit which is not shown and which can also control other system regions of the fuel cell system 10 that are to be controlled, for example the conveyance units 26, 36 and the cathode gas heating unit 28, during fuel cell operation.

The cathode region 16 is further associated with a cathode bypass line 44 having a bypass valve unit 46. Through the cathode bypass line 44 with the bypass valve unit 46 open, at least a portion of the cathode gas conveyed toward the cathode region 16 can be conducted parallel to the cathode region 16 and flow toward the cathode outlet line 40. When the bypass valve unit 46 is in a closed position, the cathode bypass line 44 is blocked to prevent cathode gas from flowing through, such that all the cathode gas conveyed by the cathode gas conveyance unit 26 flows into the cathode region 16 in the region of the cathode inlet region 24.

The fuel cell system 10 further includes a buffer store 48 for anode offgas released from the anode region 14. The buffer store 48 is associated with a buffer store inlet line 50 which is connected to the anode return line 34 and, for example, branches off therefrom downstream of the anode outlet region 32.

The buffer store inlet line 50 is associated with a buffer store valve unit 52 via which the buffer store inlet line 50 is blockable to prevent anode offgas from flowing through and via which the buffer store inlet line 50 can be unblocked to allow conduction of anode offgas toward the buffer store 48 when carrying out the anode region flushes.

The buffer store 48 is further associated with a buffer store outlet line 54 which runs from the buffer store 48 to the cathode outlet line 40 and opens thereinto downstream of the cathode valve unit 42, for example downstream of the mouth of the cathode bypass line 44 as well.

The buffer store outlet line 54 is associated with a buffer store restrictor or throttle unit 56, for example in the form of an orifice plate, which restricts or throttles the flow of anode offgas received or temporarily stored in the buffer store 48 and thus causes a delay in the release of anode offgas received in the buffer store 48 when carrying out an anode region flush. Advantageously, the buffer store restrictor unit 56 is a variable restrictor unit, the restricting behavior, that is, flow resistance, of which is alterable. The buffer store restrictor unit 56 may also be used to completely block the buffer store outlet line 54 to prevent the release of anode offgas from the buffer store 48. Just like the other system regions which are variable with respect to their operating state during fuel cell operation, for example the various valve units 42, 46, 52, the conveyance units 26, 36 and the cathode gas heating unit 28, the buffer store restrictor unit 56 may also be under the control of a control unit of the fuel cell system 10.

The buffer store 48 is further associated with a fluid outlet line 58. Water which has been discharged from the anode region 14 with the anode offgas and is accumulating in the buffer store 48 can be collected in a lower region of the buffer store 48 and released via the fluid outlet line 58. The fluid outlet line 58 may be associated with a fluid valve unit 60 which, when an amount, for example determined amount, of water has been accumulated in the buffer store 48, can then open or be opened in order to drain away the water and thus prevent discharge of water from the buffer store 48 via the buffer store outlet line 54. The fluid valve unit 60 is also under the control of the control unit. Alternatively, the fluid valve unit may be a passive valve unit, for example one that is controlled by a float, which subsequently opens when a defined fluid level has been reached in the buffer store 48. The water drained away from the buffer store 48 via the fluid outlet line 58 may be, for example, released to the environment or may alternatively also be returned to the fuel cell process.

Downstream of where the buffer store outlet line 54 opens into the cathode outlet line 40 is provided a catalyst unit 62. In the catalyst unit 62, a catalytic reaction is carried out to allow the reaction of hydrogen with oxygen to form water, thus making it possible to substantially prevent the emission of molecular hydrogen to the environment.

During normal fuel cell operation, the anode region 14 is supplied with hydrogen and the cathode region 16 is supplied with oxygen. In an electrochemical reaction, electrical energy is generated and water is formed at the same time in the cathode region, and this water is released into the cathode outlet line 40 at the cathode outlet region 38 together with the nitrogen present in the air supplied to the cathode region 16 as cathode gas.

Since a portion of the water formed in or introduced into the cathode region 16 and also a portion of the nitrogen can diffuse into the anode region 14 through the membrane 30, anode region flushes, also referred to as purges, are carried out repeatedly, the flushes involving opening the buffer store valve unit 52 briefly to allow conduction of the or a majority of the anode offgas toward the buffer store 48. Owing to the pressure difference between the anode region 14 and the environment and also the buffer store 48, the contaminants which accumulate in the anode region 14 are efficiently discharged within a comparatively short period of time of 0.1 to 1 second. They are conducted, together with hydrogen fed into the anode region 14, into the buffer store 48 via the buffer store inlet line 50.

The anode offgas containing a high proportion of molecular hydrogen is temporarily stored in the buffer store 48 when such an anode region flush is carried out, and it is conducted with a time delay, owing to the restricting action of the buffer store restrictor unit 56, through the buffer store outlet line 54 into the cathode outlet line 40 and, through this, into the catalyst unit 62. Hydrogen is therefore not released into the catalyst unit 62 all at once in substantial synchronicity with carrying out the anode region flushes; instead, it is released in a smoothed manner owing to the buffering action of the buffer store 48, thus preventing the formation of concentration peaks or quantitative peaks of molecular hydrogen downstream of the buffer store 48 and, in particular, in the region of the catalyst unit 62. It is therefore not necessary to oversize the catalyst unit 62 in order to thereby ensure that the hydrogen can be completely oxidized. Owing to the delayed, smoothed release of hydrogen toward the catalyst unit 62, it also operates in the intervals between two consecutive anode regions flushes in a virtually continuous process, thus making it possible to avoid cooling of the catalyst unit and to also avoid excessive accumulation of water released from the cathode region 16 in the catalyst unit 62.

The restricting action of the buffer store restrictor unit 56 may be adjusted in line with the load state of the fuel cell 12 such that it is ensured, for each load state and substantially independently of the load state of the fuel cell 12, that the anode offgas introduced into the buffer store 48 during an anode region flush can be substantially completely released from the buffer store 48 before the next anode region flush is carried out. This means that, if a larger amount of hydrogen is introduced into the anode region 14 in the event of a higher fuel cell load and, accordingly, a larger amount of anode offgas is conducted toward the buffer store 48 when carrying out an anode region flush, the restricting action of the buffer store restrictor unit 56 can be lowered in order to ensure that this amount of anode offgas can be substantially completely released to the catalyst unit 62 before the next anode region flush to be carried out. If the fuel cell load is low and, accordingly, a lower amount of hydrogen is introduced into the anode region 14, with also a lower amount of anode offgas being introduced into the buffer store 48 when carrying out an anode region flush, the restricting action of the buffer store restrictor unit 56 can be increased, thus equally ensuring a substantially continuous release of this lower amount of anode offgas to the catalyst unit 62 during the subsequent interval of operating the fuel cell 12.

When the buffer store valve unit 52 is opened to carry out anode region flushes, the pressure in the anode region 14 decreases spontaneously. In order to avoid any damage to the membrane 30 due to an excessively large pressure difference between the anode region 14 and the cathode region 16, it is beneficial if the gas pressure in the cathode region 16 is also lowered in line with the lowered gas pressure in the anode region 14 while carrying out an anode region flush. For example, the restricting action of the cathode valve unit 42 operated as a pressure control valve may be lowered for this purpose, such that a lower flow resistance at the cathode outlet region 38 results in a corresponding pressure drop in the cathode region 16. Alternatively or additionally, the bypass valve unit 46 may be opened to allow at least a portion of the cathode gas to be conducted parallel to, that is, to be conducted past, the cathode region 16 into the cathode outlet line 40. If the cathode gas heating unit 28 is also operated, what can be ensured at the same time as a result of supplying comparatively warm cathode gas, that is, comparatively warm air, is thermal conditioning of the catalyst unit 62 and discharge of moisture which accumulates in the catalyst unit 62, thereby reducing the risk of hydrothermal aging. For maximum utilization of this effect, it is possible, for example, to bring the cathode valve unit 42 to its position of complete blocking of the cathode outlet line 40, such that all the air conveyed as cathode gas by the cathode gas conveyance unit 26 toward the cathode inlet region 24 flows through the cathode bypass line 44 toward the catalyst unit 62 together with the anode offgas released from the buffer store 48.

In the fuel cell system 10, the storage volume of the buffer store 48, the restricting action of the buffer store valve unit 52 and the restricting action of the buffer store restrictor unit 56 are mutually coordinated such that, when an anode region flush is carried out, the spontaneously occurring pressure drop at the anode outlet region 32 on opening of the buffer store valve unit 52 causes the water droplets present in the anode region 14 to be sufficiently accelerated for substantially complete discharge from the anode region 14. At the same time, the buffer store 48 must be of such a volume that, when anode offgas is flowing into the buffer store 48, in particular at the beginning of such an anode region flush, a sufficient pressure difference is maintained to ensure the discharge of water or water droplets from the anode region 14. Furthermore, the preferably variable flow cross-section of the buffer store restrictor valve 56 must be dimensioned or adjusted so as to ensure that, in an interval of operating the fuel cell 12 between two immediately consecutive anode region flushes, substantially all the anode offgas previously received in the buffer store 48 can be released via the buffer store outlet line 54. The restricting action of the buffer store restrictor unit 56 may advantageously also be coordinated with the control of the bypass valve unit 46 in order, firstly, to be able to desirably influence the pressure conditions in the region of the fuel cell 12 as well and, secondly, to ensure that all the hydrogen conducted to the catalyst unit 62 via the buffer store outlet line 54 can be catalytically converted with oxygen transported in the cathode gas.

Furthermore, the fluid valve unit 60 may be coordinated with the operation of the fuel cell 12 and the performance of the anode region flushes so as to ensure that water which accumulates in the buffer store 48 is released when the pressure inside the buffer store 48 has already distinctly fallen. Since, at this point, the flow of anode gas is already reduced, the risk of water droplets being carried from the buffer store 48 toward the catalyst unit 62 is reduced. At the same time, the evening of the flow of anode offgas to the catalyst unit 62 ensures that phases of the anode offgas having an excessively high flow rate are avoided, which means that the anode offgas introduced into the catalyst unit 62 has a sufficiently long residence time in the catalyst unit 62, even in the case of a comparatively small-sized catalyst unit 62, and a substantially complete catalytic reaction can be achieved.

It is understood that the foregoing description is that of the preferred embodiments of the invention and that various changes and modifications may be made thereto without departing from the spirit and scope of the invention as defined in the appended claims.

1. A fuel cell system comprising:
at least one fuel cell defining an anode region having an anode inlet whereat said anode region is fed with hydrogen-containing anode gas;
said at least one fuel cell further defining a cathode region having a cathode inlet whereat said cathode region is fed with oxygen-containing cathode gas;
said at least one fuel cell further defining an anode outlet region for releasing anode offgas and defining a cathode outlet region for releasing cathode offgas; and,
a buffer store for receiving anode offgas from said anode outlet region.

2. The fuel cell system of claim 1, wherein:
said buffer store is connected to said anode outlet region via a buffer store inlet line;
a buffer store valve unit is associated with said buffer store inlet line and is configured for either unblocking said buffer store inlet line to allow a feed of anode offgas to said buffer store or to block said buffer store inlet line to prevent a feed of anode offgas to said buffer store.

3. The fuel cell system of claim 2, wherein said anode outlet region is associated with an anode return line for returning anode offgas from said anode outlet region to said anode inlet region.

4. The fuel cell system of claim 3, wherein said buffer store inlet line is connected to said anode return line.

5. The fuel cell system of claim 1, wherein said cathode outlet region is associated with a cathode outlet line for releasing cathode offgas and wherein said cathode outlet line is associated with a cathode valve unit for either unblocking said cathode outlet line to allow release of cathode offgas from said cathode outlet region or blocking said cathode outlet line to prevent release of cathode offgas from said cathode outlet region.

6. The fuel cell system of claim 5, wherein said buffer store is associated with a buffer store outlet line for releasing anode offgas from said buffer store and wherein said buffer store outlet line is associated with a buffer store throttle unit for throttling the flow of anode offgas through said buffer store outlet line.

7. The fuel cell system of claim 6, wherein said buffer store throttle unit has changeable throttling behavior.

8. The fuel cell system of claim 6, wherein said buffer store outlet line opens into said cathode outlet line downstream of said cathode valve unit.

9. The fuel cell system of claim 8, wherein a catalyst unit is provided for at least one of the following: i) receiving cathode offgas from said cathode outlet region; and, ii) receiving anode offgas from said anode outlet region.

10. The fuel cell system of claim 9, wherein said cathode outlet line opens into said catalyst unit downstream of said cathode valve unit.

11. The fuel cell system of claim 10, wherein said buffer store outlet line opens into said cathode outlet line upstream of said catalyst unit.

12. The fuel cell system of claim 5, wherein said cathode region is associated with a cathode bypass line and wherein said cathode bypass line is associated with a bypass valve unit for either unblocking said cathode bypass line to allow conduction of cathode gas parallel to said cathode region or blocking said cathode bypass line to prevent conduction of cathode gas parallel to said cathode region.

13. The fuel cell system of claim 12, wherein said cathode bypass line opens into said cathode outlet line downstream of said cathode valve unit.

14. The fuel cell system of claim 12, wherein said cathode inlet region is associated with a cathode inlet line for conducting cathode gas to said cathode region and wherein said anode region is associated with an anode inlet line for conducting anode gas to said anode region.

15. The fuel cell system of claim 14, wherein said cathode inlet line is associated with a cathode gas conveyance unit for conveying cathode gas to said cathode region and with a cathode gas heating unit for heating cathode gas conveyed to said cathode region.

16. The fuel cell system of claim 15, wherein said cathode bypass line branches off from said cathode inlet line downstream of said cathode gas heating unit.

17. The fuel cell system of claim 1, wherein said buffer store is associated with a fluid outlet line and wherein said fluid outlet line is associated with a fluid valve unit for either unblocking the fluid outlet line to allow release of fluid from said buffer store or blocking said fluid outlet line to prevent release of fluid from said buffer store.

18. A method for operating a fuel cell system including:
a fuel cell system for a vehicle, the fuel cell system including: at least one fuel cell defining an anode region having an anode inlet whereat the anode region is fed with hydrogen-containing anode gas; the at least one fuel cell further defining a cathode region having a cathode inlet whereat the cathode region is fed with oxygen-containing cathode gas; the at least one fuel cell further defining an anode outlet region for releasing anode offgas and defining a cathode outlet region for releasing cathode offgas; and, a buffer store for receiving anode offgas from the anode outlet region;
the method comprising the step of conducting anode offgas released from the anode outlet region into the buffer store when carrying out an anode region flush.

19. The method of claim 18, wherein the fuel cell system further includes:
the cathode outlet region being associated with a cathode outlet line for releasing cathode offgas and wherein the cathode outlet line is associated with a cathode valve unit for either unblocking the cathode outlet line to allow release of cathode offgas from the cathode outlet region or blocking the cathode outlet line to prevent release of cathode offgas from the cathode outlet region;
the buffer store being associated with a buffer store outlet line for releasing anode offgas from the buffer store and wherein the buffer store outlet line is associated with a buffer store throttle unit for throttling the flow of anode offgas through the buffer store outlet line; and,
the buffer store throttle unit having a changeable throttling behavior;
wherein the method further comprises the throttling behavior of the buffer store throttle unit to be adjusted depending on a load state of the fuel cell when carrying out an anode region flush.

20. The method of claim 19, wherein the throttling behavior of the buffer store throttle unit is adjusted such that the throttling action of the buffer store throttle unit decreases as the fuel cell load increases.

21. The method of claim 19, wherein a gas pressure in the cathode region is lowered when carrying out an anode region flush.

22. The method of claim 21, wherein the method further comprises lowering the gas pressure in the cathode region by adjusting the cathode valve unit in the direction of lower throttling action.

23. The method of claim 21, wherein the fuel cell system further includes the cathode region is associated with a cathode bypass line and wherein said cathode bypass line is associated with a bypass valve unit for either unblocking said cathode bypass line to allow conduction of cathode gas parallel to the cathode region or blocking the cathode bypass line to prevent conduction of cathode gas parallel to said cathode region; and, wherein the method further comprises lowering the gas pressure in the cathode region by operating the bypass valve unit to unblock the cathode bypass line.

24. The fuel cell system of claim 1, wherein said fuel cell system is for a vehicle.
